(19) United States
(12) Patent Application Publication
(10) Pub. No.: US 2006/0106272 A1
(43) Pub. Date: May 18, 2006

(54) In-situ treatment of asbestos-containing material

(76) Inventor: Paul W. Brown, State College, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/989,805

(22) Filed: Nov. 16, 2004

(51) Int. Cl. A62D 3/00

(52) U.S. Cl. 588/313

(57) ABSTRACT

The present invention relates to methods for the in-situ treatment of ACM containing chrysotile asbestos using a polycarboxylic acid such as oxalic acid. The polycarboxylic acid is introduced to the ACM while it remains substantially in place, or “in-situ,” and assists in converting the asbestos to a non-asbestos material. When the ACM is used as an insulating material, the asbestos fibers may be covered in gypsum that may be at least partially removed or dissolved away. The polycarboxylic acid may (1) directly attack the asbestos and/or (2) dissolve gypsum and form sulfuric acid capable of attacking the asbestos. Additional sulfuric acid may be introduced to assist in conversion of the asbestos to a non-asbestos form. Magnesium sulfate may be introduced to maintain the structural stability of the treated material thereby allowing it to substantially remain in place. Alternatively, the treated material may be safely removed for disposal.

### CROSS-REFERENCE TO RELATED APPLICATION

This application claims the benefit of U.S. Provisional Patent Application No. 60/______, filed on Nov. 8, 2004, entitled “In-Situ Treatment of Asbestos-Containing Material.”

### FIELD OF THE INVENTION

The present invention relates to methods for the in-situ treatment of asbestos-containing material, and more particularly relates to the use of a polycarboxylic acid such as oxalic acid to convert chrysotile asbestos into a non-asbestos form.

### BACKGROUND INFORMATION

Asbestos is the name given to several varieties of fibrous minerals that exhibit heat-resistant and chemical-resistant properties. Most commercially available asbestos contains the mineral chrysotile, which belongs to the serpentine variety. Some asbestos may include the minerals actinolite and tremolite, which belong to the group known as amphiboles. Asbestos with long fibers may be woven into fireproof garments, curtains, shields, and brake linings. Asbestos with short fibers may be compressed with binders into insulating boards, shingles, pipe coverings, paper, and molded products.

Asbestos is a hydrated metal silicate. The metal and hydroxyl groups serve as lateral connectors of the molecular chain, forming long crystals or fibers. The molecular formula for chrysotile is Mg₆Si₄O₁₁(OH)₆.H₂O. In the Si₄O₁₁ chain, each silicon atom is enclosed by a tetrahedron of four oxygen atoms, and two oxygen atoms are shared by adjacent tetrahedra to form a chain. The fibers of chrysotile asbestos are bundled together in rolled sheets.

Chrysotile asbestos is commonly used as an insulating material for steel structural components in buildings. To achieve thermal insulation, the chrysotile fibers are relatively loosely packed, allowing the fibers to entrap air and limit heat transfer. Because the fibers are loosely packed, they may be infiltrated using suitable chemicals to convert the chrysotile asbestos into a benign, non-asbestos material. To form the insulating material, the asbestos is typically mixed with vermiculite, plaster of Paris, and water. The plaster of Paris converts to gypsum, which covers the asbestos fibers to protect them from chemical attack. Removal of the gypsum is desirable to facilitate reaching the asbestos underneath and achieve effective treatment.

The prior art discloses the use of sulfuric acid to directly attack the asbestos and convert it into a non-toxic material. Patent No. WO8810234 to Bjerre et al. discloses the decomposition of asbestos fibers including chrysotile by reacting the fibers with an acid, such as a solution of sulfuric acid or an aqueous solution of ammonium sulfate. The asbestos and acid are subjected to heating and physical treatment, e.g., blending, stirring, flow, and/or comminution. The acidity of the reaction mixture is maintained at a pH of less than 5.

U.S. Pat. No. 4,818,143 to Chou discloses a method of decomposing and removing asbestos using sulfuric acid, then solidifying the material for disposal.

U.S. Pat. No. 5,041,277 to Mirick discloses the use of weak organic acids, such as acetic, cyanobenzoic, trifluoroacetic, and lactic acid, to convert insulation into non-asbestos material. The Mirick patent does not disclose the use of a dicarboxylic acid such as oxalic acid, or any other polycarboxylic acid. U.S. Pat. Nos. 5,258,131, 5,264,655, and 5,516,973 to Mirick disclose the use of a solution containing an acid and a source of fluoride ions to treat asbestos.

The prior art fails to disclose the in-situ treatment of asbestos using a polycarboxylic acid such as oxalic acid while the insulating material remains substantially intact. “In-situ treatment” refers to the treatment of asbestos in place without the need for ACM removal prior to treatment. The prior art also fails to provide a means for maintaining the structural stability, integrity, and functionality of the insulating material as the polycarboxylic acid converts the asbestos into a non-asbestos form. In addition, the prior art does not disclose the dissolution of gypsum using a polycarboxylic acid such as oxalic acid.

### SUMMARY OF THE INVENTION

The present invention provides methods for the in-situ treatment of ACM containing chrysotile asbestos using a polycarboxylic acid such as oxalic acid and/or other suitable, selected acids. The polycarboxylic acid may be used with or without the addition of an alkali silicate. The polycarboxylic acid may (1) directly attack the asbestos by converting it into a non-asbestos form and/or (2) at least partially remove gypsum from the ACM and form sulfuric acid capable of attacking the asbestos. Additional sulfuric acid may be introduced to assist in converting the asbestos to a non-asbestos form. Magnesium sulfate may be introduced to enhance the structural stability of the treated material thereby allowing it to substantially remain in place. Alternatively, the treated material may be safely removed for disposal purposes.

An object of the present invention is to provide a method for in-situ treatment of asbestos-containing material, the method comprising introducing a polycarboxylic acid to the asbestos-containing material while the material remains in place.

An object of the present invention is to provide a safe method for treating ACM that avoids the handling of hazardous asbestos materials and reduces the risk of asbestos exposure.

Another object of the present invention is to provide an economical method for treating ACM that reduces labor costs, material disposal costs, and liability related costs.

Another object of the present invention is to provide a method for treating ACM that produces non-hazardous end-products which can be safely left in place or disposed as regular construction debris.

These and other aspects of the present invention will become more readily apparent from the following detailed description and appended claims.

### TABLES

Table 1 summarizes the treatment results for testing conducted on a pipe insulated with ACM.

### FIGURES

FIGS. 1a-b are cross-polarized and plain-polarized images, respectively, of insulation prior to treatment with oxalic acid.

FIGS. 2a-b are plain-polarized images of insulation following 3 days of treatment and 8 days of treatment, respectively.

FIGS. 3a-b are SEM images of two chrysotile fibers, respectively, prior to treatment with oxalic acid.

FIG. 4 is an SEM image of a cross-section of the insulation after initial treatments.

FIG. 5 is an SEM image for a cross-section of the insulation after 3 days of treatment.

FIGS. 6a-b are images of a typical chrysotile fiber and its crystalline structure, respectively.

FIGS. 7a-b are images of a chrysotile fiber following 8 days of treatment and its lack of crystalline structure, respectively.

FIGS. 8a-b show the chemical composition of a typical chrysotile fiber and a chrysotile fiber following 8 days of treatment, respectively, using EDS.

FIG. 9 is a photograph of an insulated pipe prior to treatment with oxalic acid.

FIG. 10 is a photograph showing decomposition of pipe insulation following treatment with oxalic acid.

FIG. 11 is a photograph showing pipe insulation laid out in sheets after treatment with oxalic acid.

FIG. 12 is a photograph showing a close-up ofthe treated pipe insulation.

FIG. 13 is an image of a treated chrysotile fiber.

FIG. 14 is an image of an untreated chrysotile fiber bundle.

FIG. 15 is an image of a treated chrysotile fiber.

### DETAILED DESCRIPTION

The present invention provides methods for the in-situ treatment of ACM containing chrysotile asbestos using a polycarboxylic acid such as oxalic acid. The polycarboxylic acid may be used with or without the addition of an alkali silicate. The polycarboxylic acid is introduced to the ACM while it remains substantially in place, or “in-situ,” and assists in converting the asbestos to a benign, non-asbestos material. When the ACM is used as insulating material, the asbestos fibers may be coated in gypsum which may be at least partially removed or dissolved away. The polycarboxylic acid may (1) directly attack the asbestos and/or (2) dissolve the gypsum and form sulfuric acid capable of attacking the asbestos. Additional sulfuric acid may be introduced to assist in conversion of the asbestos to a non-asbestos form. Magnesium sulfate may be introduced to enhance the structural stability of the treated material thereby allowing it to substantially remain in place. Alternatively, the treated material may be safely removed for disposal.

In a preferred embodiment, the polycarboxylic acid comprises oxalic acid. Oxalic acid, also known as ethane diacid, is a dicarboxylic acid with the chemical formula 2H(O₂CCO₂)H. While the description contained herein primarily refers to the use of oxalic acid, it is to be understood that numerous other polycarboxylic acids can be used in accordance with embodiments of the present invention. For example, the polycarboxylic acid may comprise maleic acid, fumaric acid, citric acid, or a combination of these acids. The polycarboxylic acid may comprise any acid having two or more carboxyl groups per molecule.

The polycarboxylic acid is provided as part of a “treatment solution.” In a preferred embodiment, the polycarboxylic acid is provided in a saturated or substantially saturated solution, which is referred to herein as a “strong” solution. The treatment solution may also contain a slight amount of an alkali silicate, e.g., approximately 5.0 percent by weight of the solution. The solvent may comprise water, an aqueous solution containing electrolytes, or any other suitable solvent. With a saturated solution, some undissolved acid crystals may remain; the treatment solution preferably may have a reserve acidity of up to about 10 percent. Alternatively, the polycarboxylic acid may be provided in a dilute solution, which is particularly effective at treating asbestos in dust form. When the dilute solution is applied, it assists in suppressing the dust particles. As the solvent evaporates, a concentrated solution is left to attack the asbestos. The dilution of the solution may depend on the size of the dust particles and the size of the solution droplets. The concentration of polycarboxylic acid in a dilute solution should be sufficient enough to neutralize the asbestos in the dust particles.

As an alternative to using a treatment solution that primarily contains oxalic acid, the treatment solution may contain mixtures of organic acids. For example, a mixture of oxalic acid and maleic acid anhydrite may be used, or a mixture of oxalic acid and itaconic acid. The compounds may be mixed together prior to introducing the treatment solution to the ACM. The compounds may be provided in any amount sufficient to treat the asbestos.

In a preferred embodiment, the treatment solution should be capable of substantially infiltrating the space between asbestos fibers and wetting the surfaces of the asbestos fibers to ensure that the asbestos is susceptible to chemical treatment. The solution should also interact electrostatically with magnesium ions which permit the asbestos to assume a fibrous morphology by forming rolled sheeting. In addition, the solution should be capable of abstracting magnesium from the asbestos, which converts the mineral to a non-asbestos form both morphologically and compositionally. The solution should also be capable of complexing with magnesium to have the process of chemical reaction reach completion. The treatment solution is preferably non-flammable and non-carcinogenic, with a low volatility.

When chrysotile asbestos is used as an insulating material, it is typically mixed with vermiculite, plaster of Paris, and water. The plaster of Paris converts to gypsum, which covers the asbestos fibers and protects them from chemical attack. The present methods at least partially remove or dissolve away the gypsum, allowing the treatment solution to reach the asbestos. Oxalic acid may be used to convert gypsum into calcium oxalate monohydrate and sulfuric acid. Rather than relying on the oxalic acid alone, one or more additional chemicals, e.g., an acid that forms a generally insoluble salt (less than about one-tenth molar solution), may be included in the treatment solution to assist in removing the gypsum by chemical conversion.

Depending on the concentration produced, the sulfuric acid may directly attack the asbestos. Additional sulfuric acid may be introduced to the treatment solution, or provided in a separate solution that is applied directly to the ACM, to enhance the rate of asbestos treatment. The sulfuric acid may be provided in any amount sufficient to facilitate the treatment of asbestos.

The oxalic acid may directly attack the asbestos, forming magnesium oxalate dihydrate, magnesium hydroxide (brucite), and amorphous silica according to the following reaction: 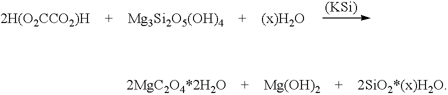
Although x is not limited to any particular value, the minimum value for x may be such that 10 percent reserve acidity is present, and the maximum value for x may be related to neutralizing asbestos in dust. In a preferred embodiment, the treatment solution may have a pH of about 0.6 to 2.0. In another preferred embodiment, the pH is about 0.7. However, the treatment solution is not limited to any particular pH value. Depending on the acidity of the system, the asbestos may not be fully treated by the oxalic acid and sulfuric acid. In this event, maleic acid or fumaric acid may be introduced to the treatment solution, or provided in a separate solution that is applied directly to the ACM, to provide further asbestos treatment. If the maleic or fumaric acid may be provided in any amount sufficient to facilitate the treatment of asbestos. Maleic and fumaric acids are more soluble in water or other aqueous solution than oxalic acid and produce more acidic solutions.

In addition to treating the asbestos, it is desirable to maintain the structural stability, integrity, and functionality of the ACM itself, allowing it to remain in place and eliminating the need for removal and disposal. For example, if the ACM is contained in the insulation surrounding a pipe, it is desirable for the insulating material to remain substantially in place around the pipe following asbestos treatment. This can be accomplished by introducing magnesium sulfate to the treatment solution. A high proportion of magnesium sulfate is desirable, although the magnesium sulfate may be provided in any amount sufficient to maintain or enhance the stability of the material. The magnesium sulfate should not significantly interfere with the action of the oxalic acid. Some magnesium may be consumed in forming magnesium oxalate.

The addition of magnesium sulfate forms an acidic compound, MgSO₄H₂SO₄.3H₂O, that incorporates water and contributes to the gelation of the attacking medium. As asbestos (magnesium silicate) and gypsum (calcium sulfate) are destroyed, hydrous silica is formed along with magnesium oxalate and/or magnesium sulfate. In addition, depending on the proportion of oxalic acid originally present, sulfuric acid may remain. This assemblage of compounds can be converted into a cement called magnesium oxysulfate cement by decreasing the acidity of the system. The acidity can be decreased by adding a source of base such NaOH, KOH, CaOH, Na₂CO₃, Na₂PO₄, or the like. Other cements may result from the formation of magnesium sulfate hydrates, including MgSO₄.2H₂O, MgSO₄.4H₂O, MgSO₄.6H₂O, MgSO₄.7H₂O, and 3Mg(OH)₂.MgSO₄.8H₂O.

In a preferred embodiment, an alkali silicate, e.g., sodium silicate, potassium silicate, or a mixture of the two, may be added to the treatment solution prior to introducing it to the ACM. The alkali silicate serves as a catalyst, providing lubricity and facilitating the formation of magnesium silicate, magnesium oxalate, and alkali oxalates. The alkali silicate may be added in any amount that is sufficient to facilitate the formation of these compounds, with a preferred range of up to about 10.0 weight percent of solution. In preferred embodiment, the alkali silicate may be added in an amount of about 5.0 weight percent of solution.

In another embodiment, a surfactant may be added to the treatment solution to facilitate reaction. The surfactant serves as a surface active agent that promotes wetting of the surfaces of the asbestos fibers. Examples of such surfactants include sodium laurel sulfate or Tween, which refers to a series of commercially available emulsifiers and surface active agents that are polyoxyethylene derivatives of fatty acid partial esters of sorbitol anhydrides. The surfactant is preferably provided in the range of about 0.1 to 1.0 percent by weight of the treatment solution. The surfactant may be cationic, anionic, or non-ionic.

The treatment solution can be introduced to the ACM using various techniques including spraying. The treatment solution may also be introduced using inoculation or injection. In addition, a textile may be applied to the ACM and saturated with the treatment solution. The textile is preferably saturated with the treatment solution following application to the ACM, although it may also be saturated before application to the ACM. The textile may comprise a synthetic or non-synthetic material, burlap, cotton, mixed rags, or any other material that will not be immediately attacked by the treatment solution. If the ACM contains asbestos dust, the treatment solution may be diluted to assist in dust suppression. As the dilute solution evaporates, it forms a concentrated solution of polycarboxylic acid and eventually a saturated solution.

In a preferred embodiment, the ACM is saturated daily, approximately once every 24 hours, and allowed to dry between applications. The amount of treatment solution applied is dependent on the volume and type of ACM being treated, and the material's absorptivity. Submerging the ACM in solution accelerates the treatment process. Once the ACM has been treated, it may be safely removed from its in-situ state for subsequent disposal or simply left in place.

Regardless of the method of treatment employed, the treatment process may be conducted at ambient or naturally occurring temperatures. In the case of insulation surrounding a pipe, the naturally occurring temperature may be the temperature of heated water or other materials that are flowing through the pipe.

The chemicals produced from the treatment process are safe. Magnesium oxalate dihydrate occurs naturally as a mineral. It is used in some ceramic and refractory applications. Magnesium oxalate dehydrate has no known chronic health effects and is not listed by the NTP, IARC, or OSHA as a carcinogen. Magnesium hydroxide, also called brucite, is used as an antacid (milk of magnesia), sugar refiner, osmotic laxative, flame retardant, paper pulp bleacher, and water treatment product to neutralize acid, precipitate heavy metals, scrub sulfur dioxide, and remove metals from waste streams. Magnesium hydroxide has no known chronic health effects and is not listed by the NTP, IARC, or OSHA as a carcinogen. The amorphous silica fibers that are produced appear to be less hazardous than commercially produced silica fibers. The magnesium-leached silica fibers ofthe present invention are damaged and therefore weaker than their commercially produced counterparts. Once the magnesium has been leached from the chrysotile fiber, amorphous fibers remain, which are prone to destruction in the lungs and pose a lower health risk.

The methods of the present invention can lead to significant reductions in labor costs, material disposal costs, and liability related costs. The invention mitigates the need to handle hazardous asbestos materials and to implement asbestos-related safety precautions and training. The removal of asbestos may be eliminated entirely. No specialized equipment is required to execute the invention and disposal fees should equal the regular rates for non-hazardous construction debris.

### EXAMPLES

The following examples are intended to illustrate the invention and should not be construed as limiting the invention in any way.

### Example 1

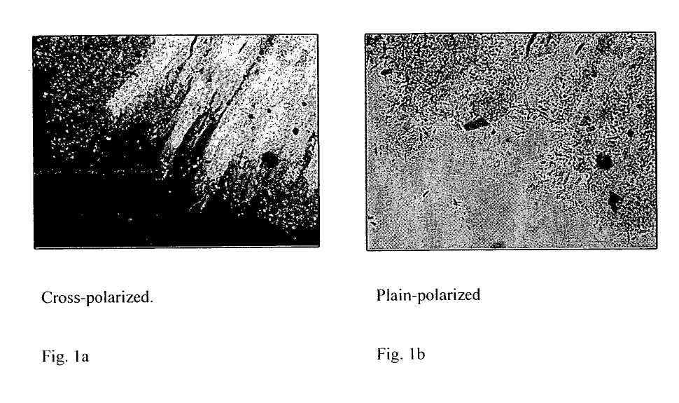

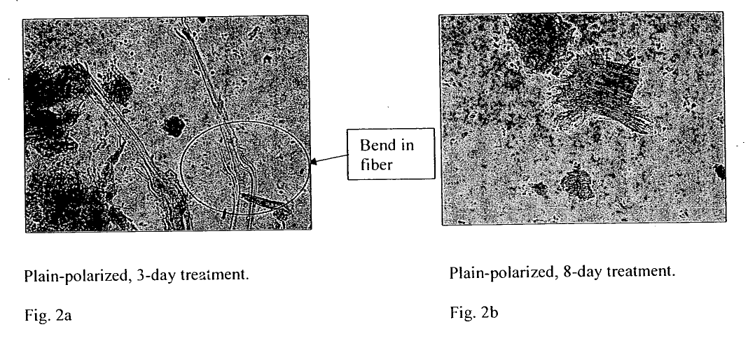

A portion of spray-on insulation material, containing approximately 10 weight percent asbestos, was treated with a solution containing oxalic acid and potassium silicate in a laboratory setting for a 6-day period. Polarized light microscopy (PLM) showed that following treatment, bundles of chrysotile fibers were separated or broken down, and their indices of refraction had changed. FIG. 1a shows a cross-polarized light image of the insulation before treatment. FIG. 1b shows a plain-polarized light image. FIG. 2a shows a plain-polarized image after 3 days of treatment. FIG. 2b shows a plain-polarized image after 8 days of treatment.

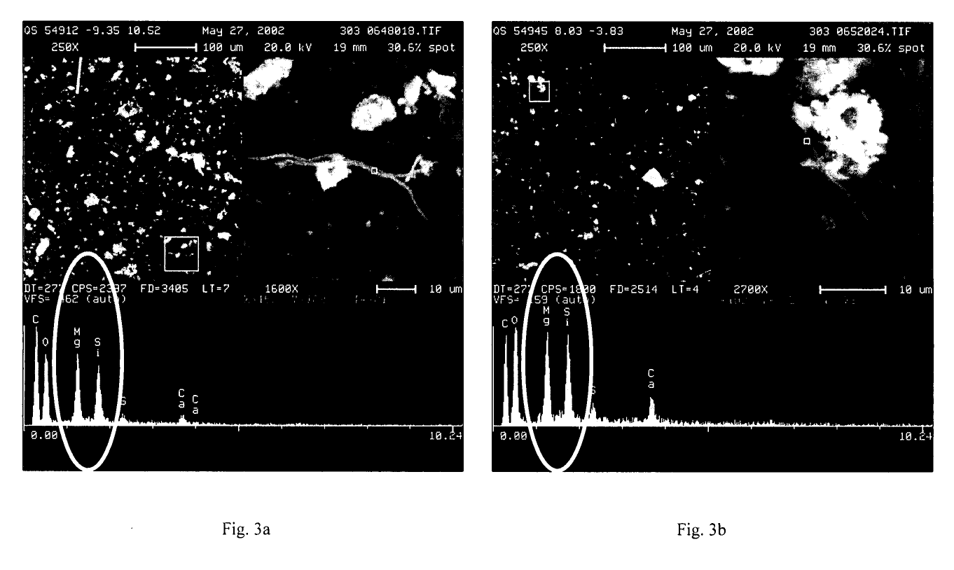

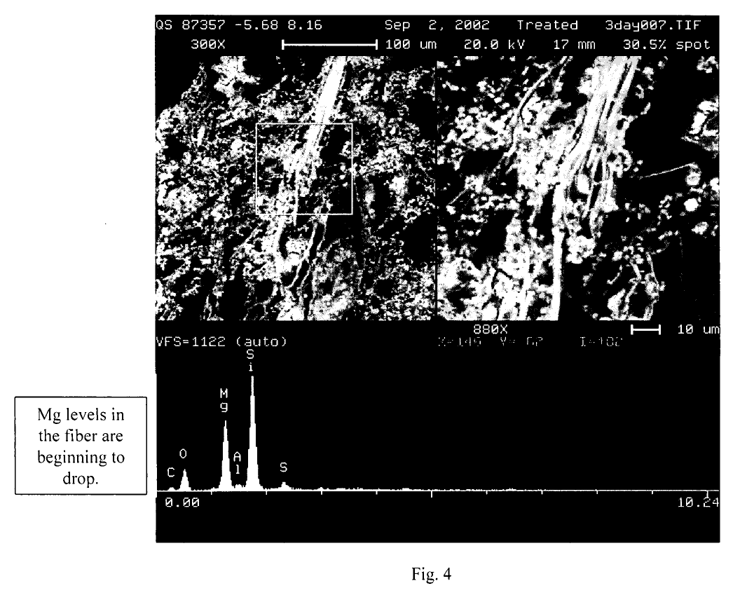

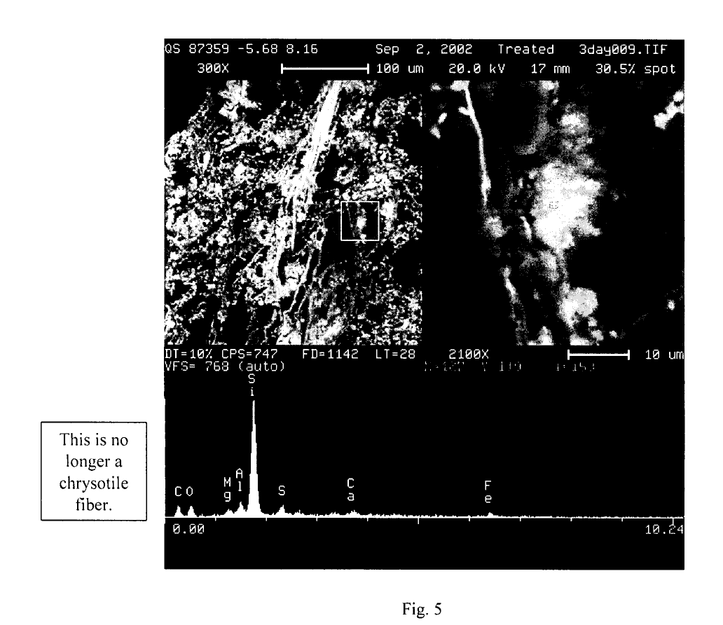

Scanning electron microscopy (SEM) was used to produce images and chemical composition spectra of the treated insulation material. SEM produces an electron beam that is used to generate images of the surface of a material in much the same manner as reflective light microscopy; the electron beam will also induce X-rays characteristic of the elements comprising the material. The evaluation of the characteristic X-rays is performed by a technique called energy dispersive spectroscopy (EDS). FIGS. 3a and 3b present the SEM image for two chrysotile fibers prior to treatment. FIG. 4 presents the SEM image of a cross-section of the insulation after initial treatments began removing magnesium from the chrysotile fiber. As shown in the chemical composition spectrum, magnesium levels started to drop. FIG. 5 presents the SEM image for a cross-section of the insulation after 3 days of treatment. As shown in the chemical composition spectrum of FIG. 5, the magnesium was almost completely removed, and there was no longer a chrysotile fiber.

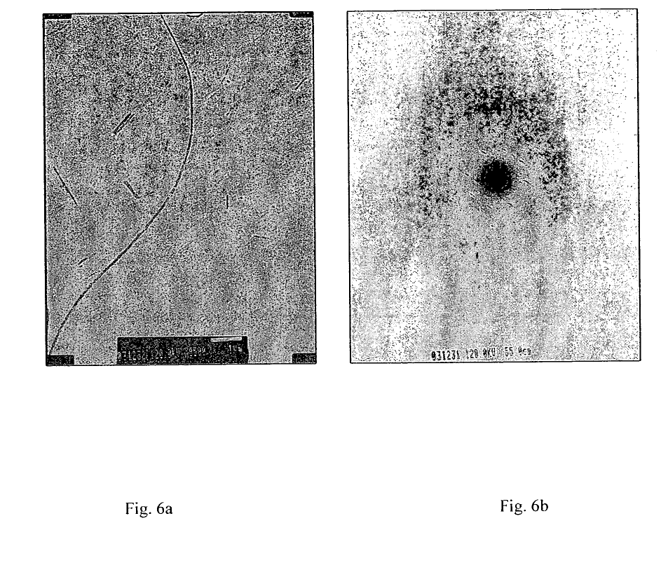

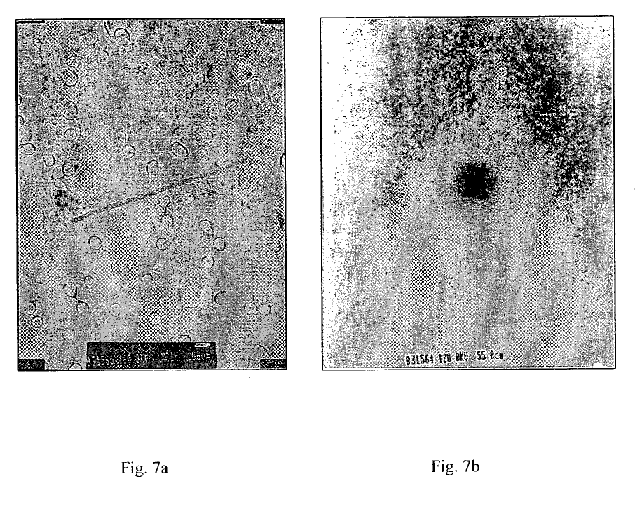

Transmission electron microscopy (TEM) was used to produce images of the material's crystal lattice. FIG. 6a shows an image of a fiber, and FIG. 6b shows the Selected Area Electron Diffraction (SAED) image for this same chrysotile fiber. The diffraction pattern indicates that before treatment the fiber is crystalline and has a particular crystal structure. FIG. 7a shows an image of a fiber, and FIG. 7b shows the SAED image for the same fiber following 8 days of treatment. There is no diffraction pattern for this treated fiber; the fiber appears to be amorphous or glass-like with no crystal structure. The requirements for the fiber to be defined as asbestos are as follows: 1) the morphology must have an aspect ratio (length to width) of at least 3:1; 2) the fiber must have the crystalline structure for the particular type of asbestos (in this case, chrysotile); and 3) the fiber must have the correct chemistry of magnesium silicate (magnesium and silicon need to be identified and generally have the correct ratio). After treatment, two of these three criteria are no longer met.

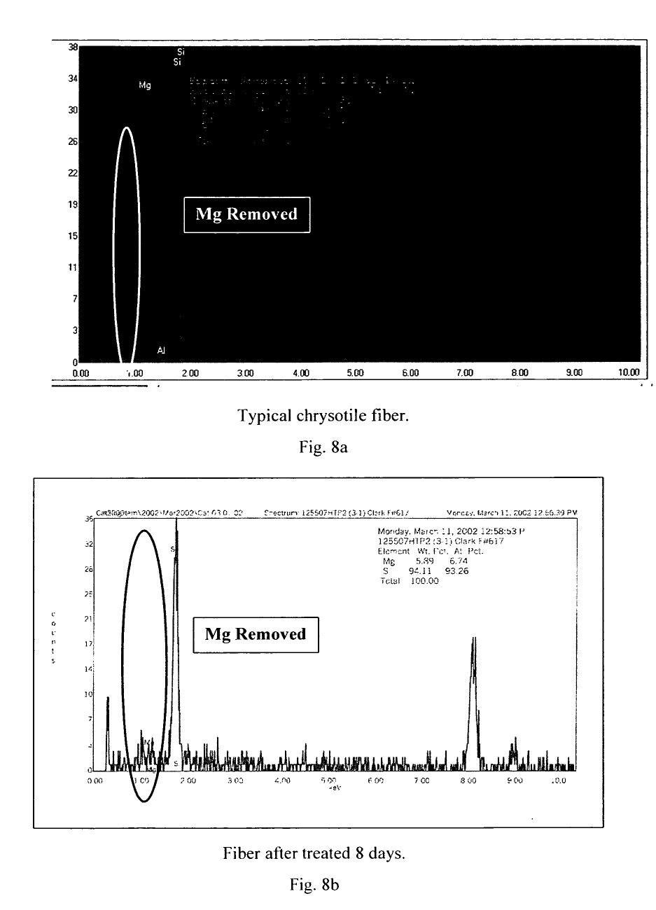

FIG. 8a presents the chemical composition of a typical chrysotile fiber using EDS. FIG. 8b presents the chemical composition of a fiber following 8 days of treatment. As shown, the magnesium has been substantially removed.

### Example 2

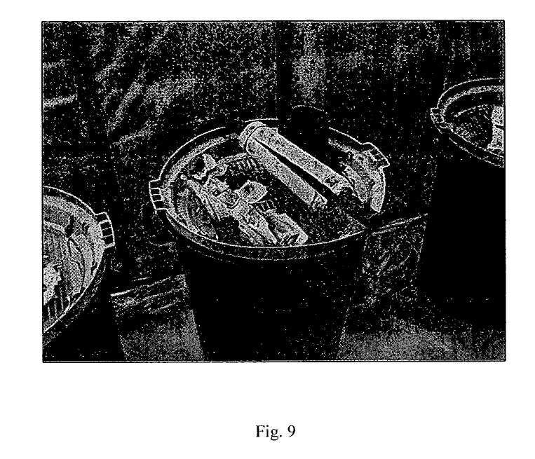

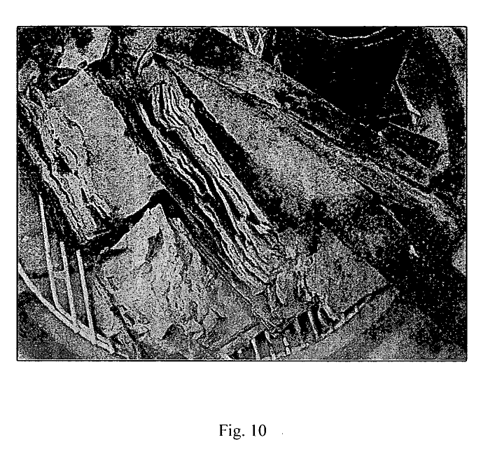

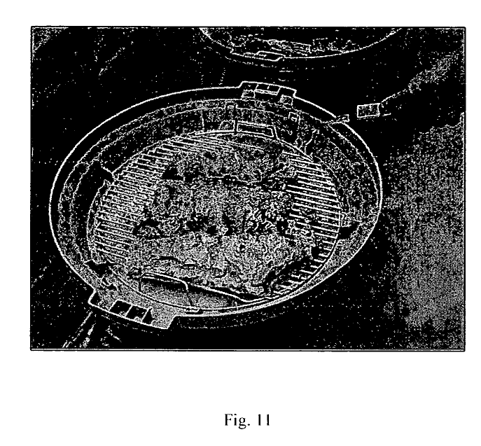

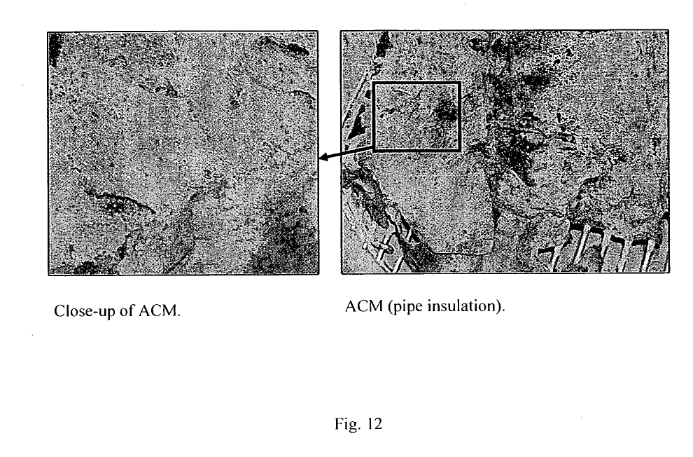

A control experiment was conducted on a section of pipe surrounded with ACM to test the efficacy of an oxalic acid/potassium silicate solution. FIG. 9 presents a photograph of the insulated pipe prior to treatment. The insulation contained up to 70 percent chrysotile asbestos. The ACM was treated with a saturated solution of oxalic acid containing about 5 percent by weight of potassium silicate. The ACM was fully saturated on a daily basis approximately once every 24 hours for about 10 days, and allowed to dry between applications. FIG. 10 shows the decomposition of the pipe insulation after two applications. FIG. 11 shows the insulation removed from the pipe and laid out in sheets, and fully saturated with treatment solution. Magnesium continued to leach from the chrysotile fibers for approximately 10 days. Table 1 summarizes the treatment results. Two different treatment routes were used: 1) the treatment solution was sprayed onto the ACM (“saturated”), and 2) a portion of the ACM was placed in a beaker that was filled with the treatment solution (“submerged”). FIG. 12 shows a close-up of the treated ACM and the small, crystal-like structures that formed on the surface after the first application.

### Example 3

Laboratory bench tests were conducted where chrysotile was submerged in a beaker of saturated oxalic acid and 5 Wt. % potassium silicate. In the first series a known amount of chrysotile (approximately 1 gram) was submerged in a known amount of solution (500 milliliters) and was evaluated to determine the amount of magnesium leached. Ten milliliters of solution was drawn off daily and characterized by inductively coupled plasma (ICP) analysis. The results indicate that 70 Wt. % of the magnesium is leached from the chrysotile within one week.

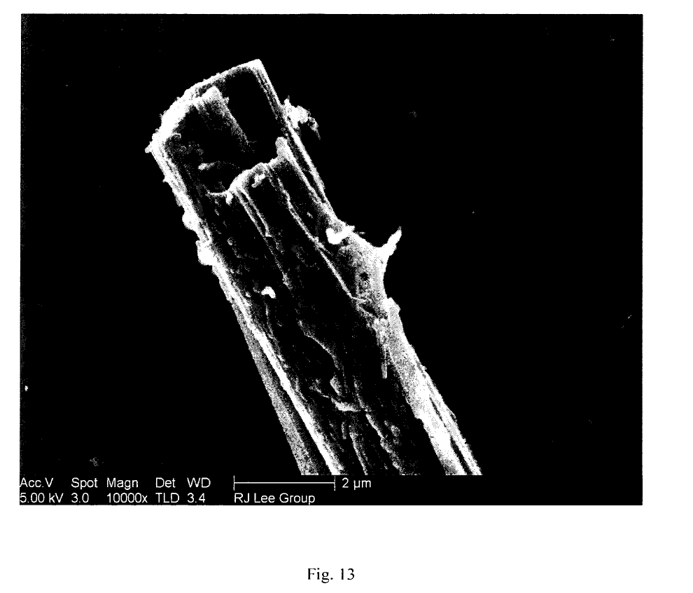

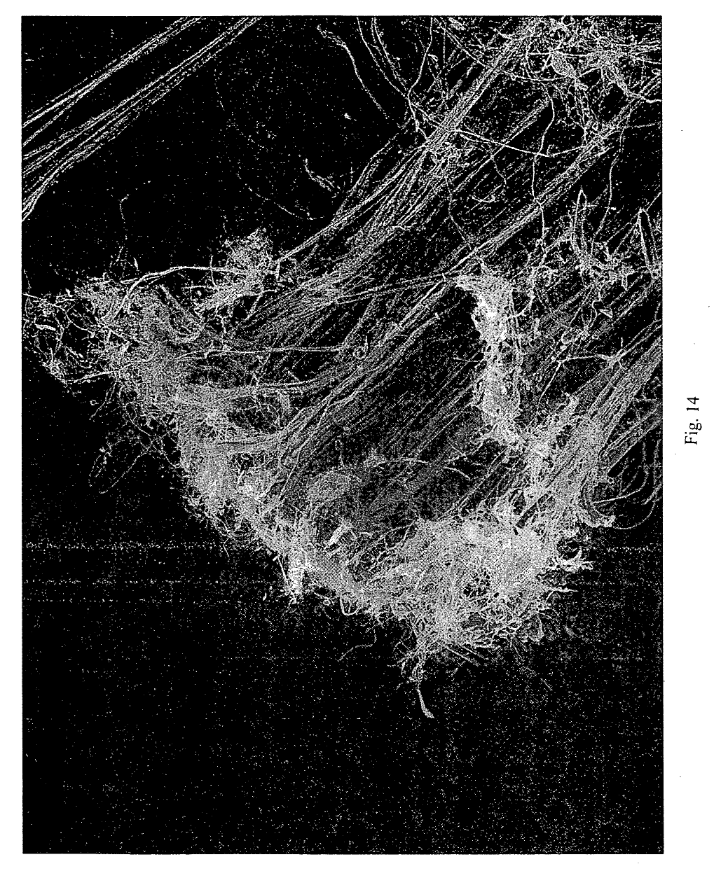

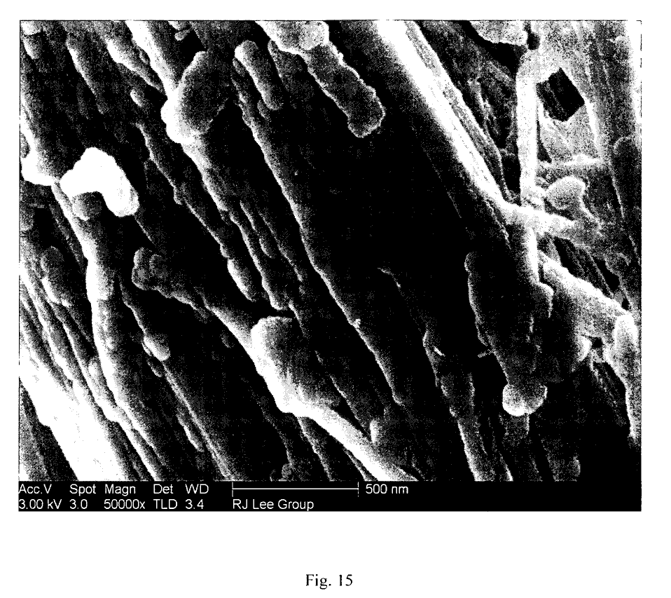

In a second series chrysotile was submerged in treatment solution and fibers withdrawn for analysis by TEM and SEM. FIG. 13 shows a SEM image of a treated chrysotile fiber bundle; after treatment (submerged) for 6 days in saturated oxalic acid and 5 Wt. % potassium silicate. The figure shows that the fiber morphology has been changed during treatment; splayed ends are not apparent, as seen in FIG. 14 of an untreated chrysotile fiber bundle. FIG. 15 shows a higher magnification ofthe same fiber bundle shown in FIG. 13; at higher magnifications the fiber structure can be seen to have been disrupted.

Whereas particular embodiments of this invention have been described above for purposes of illustration, it will be evident to those skilled in the art that numerous variations of the details of the present invention may be made without departing from the invention as defined in the appended claims.

TABLE 1
Treatment Results Summary

| Component | Sprayed | Sprayed | Submerged | Submerged |
|---|---|---|---|---|
| Treated | for 3 Days | for 6 Days | for 3 Days | for 6 Days |
| Layered Pipe | 10% | 60% | 80% | 90% |
| Insulation | Converted | Converted | Converted | Converted |
| (originally 70% | | | | |
| chrysotile) | | | | |

What is claimed is:

1. A method for in-situ treatment of asbestos-containing material, comprising introducing a polycarboxylic acid to the asbestos-containing material while the material remains in place.

2. The method of claim 1, wherein the polycarboxylic acid at least partially removes gypsum from the asbestos-containing material.

3. The method of claim 1, further comprising prior to said introducing, mixing the polycarboxylic acid with at least one additional chemical capable of at least partially removing gypsum from the asbestos-containing material.

4. The method of claim 1, wherein the polycarboxylic acid converts at least some of the asbestos-containing material into a non-asbestos form.

5. The method of claim 1, wherein the polycarboxylic acid comprises oxalic acid.

6. The method of claim 5, wherein the oxalic acid is provided in a saturated or substantially saturated solution.

7. The method of claim 5, further comprising prior to said introducing, mixing the oxalic acid with maleic acid anhydrite.

8. The method of claim 5, further comprising prior to said introducing, mixing the oxalic acid with itaconic acid.

9. The method of claim 1; further comprising prior to said introducing, mixing the polycarboxylic acid with an alkali silicate to accelerate asbestos treatment.

10. The method of claim 9, wherein at least one alkali silicate is selected from the group comprising potassium silicate and sodium silicate.

11. The method of claim 9, wherein the alkali silicate is provided in up to about 10.0 percent by weight of a solution.

12. The method of claim 9, wherein the alkali silicate is provided in about 5.0 percent by weight of a solution.

13. The method of claim 1, wherein the polycarboxylic acid forms sulfuric acid that converts at least some of the asbestos-containing material into a non-asbestos form.

14. The method of claim 1, wherein at least one polycarboxylic acid is selected from the group comprising maleic acid, fumaric acid, and citric acid.

15. The method of claim 1, further comprising introducing sulfuric acid to the asbestos-containing material to convert at least some of the asbestos-containing material into a non-asbestos form.

16. The method of claim 1, further comprising prior to said introducing, mixing the polycarboxylic acid with magnesium sulfate and a base to substantially maintain structural stability of the material.

17. The method of claim 16, wherein the magnesium sulfate participates in the formation of a cement that substantially maintains the structural stability of the material.

18. The method of claim 17, wherein the cement comprises magnesium oxysulfate cement.

19. The method of claim 16, wherein at least one base is selected from the group comprising NaOH, KOH, CaOH, Na₂CO₃, and Na₃PO₄.

20. The method of claim 1, further comprising prior to said introducing, mixing the polycarboxylic acid with a surfactant to promote wetting of asbestos fibers.

21. The method of claim 20, wherein at least one surfactant is selected from the group comprising an anionic surfactant, a cationic surfactant, and a non-ionic surfactant.

22. The method of claim 20, wherein the surfactant comprises sodium laurel sulfate

23. The method of claim 20, wherein the surfactant is provided in about 0.1 to 1.0 percent by weight of a solution.

24. The method of claim 1, wherein space exists between asbestos fibers.

25. The method of claim 24, wherein a solution comprising the polycarboxylic acid infiltrates the space between asbestos fibers.

26. The method of claim 1, wherein a solution comprising the polycarboxylic acid wets surfaces of asbestos fibers.

27. The method of claim 1, wherein the asbestos-containing material remains at about ambient temperature during treatment.

28. The method of claim 1, wherein a solution comprising the polycarboxylic acid is introduced by spraying on the asbestos-containing material.

29. The method of claim 1, wherein a solution comprising the polycarboxylic acid is introduced by inoculating the asbestos-containing material with the solution.

30. The method of claim 1, wherein a solution comprising the polycarboxylic acid is introduced by applying a textile to the asbestos-containing material.

31. The method of claim 30, wherein the textile is saturated with the solution comprising the polycarboxylic acid.

32. The method of claim 1, wherein the treated material is removed for disposal.

33. The method of claim 1, wherein the asbestos-containing material includes asbestos dust.

34. The method of claim 33, wherein the polycarboxylic acid is provided in a dilute solution.

35. The method of claim 1, wherein a solution comprising the polycarboxylic acid is introduced to the asbestos-containing material at least once every 24 hours.

36. The method of claim 35, wherein a solution comprising the polycarboxylic acid is introduced to the asbestos-containing material periodically for at least about 3 days.

37. The method of claim 35, wherein a solution comprising the polycarboxylic acid is introduced to the asbestos-containing material periodically for at least about 8 days.

38. The method of claim 35, wherein a solution comprising the polycarboxylic acid is introduced to the asbestos-containing material periodically for at least about 10 days.

39. The method of claim 1, wherein the polycarboxylic acid is provided in a solution having a pH of about 0.6 to about 2.0.

40. The method of claim 1, wherein the polycarboxylic acid is provided in a solution having a pH of about 0.7.
